(19) United States
(12) Patent Application Publication
(10) Pub. No.: US 2023/0054327 A1
(43) Pub. Date: Feb. 23, 2023

(54) COLLABORATIVE LOCALIZATION OF A VEHICLE USING RADIOLOCATION

(71) Applicant: TOYOTA RESEARCH INSTITUTE, INC., Los Altos, CA (US)

(72) Inventors: Hiroshi Yasuda, San Francisco, CA (US); Manuel Ludwig Kuehner, Mountain View, CA (US); Alexander Christoph Schaefer, Heuweiler (DE)

(21) Appl. No.: 17/407,115

(22) Filed: Aug. 19, 2021

(51) Int. Cl. G01S 5/10; G01S 5/02; G01S 19/01; G01C 21/00

(52) U.S. Cl. CPC G01S 5/10; G01S 5/0284; G01S 19/01; G01S 5/0294; G01C 21/3841

(57) ABSTRACT

Systems and methods of collaborative localization for a vehicle are provided. In particular, one or more vehicles that are able to localize themselves with high accuracy may transmit timestamped localization information (i.e. localization packets) to a nearby vehicles which lack high-accuracy localization sensors. Each localization packet may include the location of the transmitting vehicle with respect to a global reference frame. Upon receiving the localization packets, a vehicle may use radiolocation techniques to estimate its location relative to the transmitting vehicle(s). Based on this estimation and the information in the localization packets, the vehicle may then estimate its location with respect to the global reference frame with a high degree of accuracy.

### TECHNICAL FIELD

The present disclosure relates generally to automotive systems and technologies, and more particularly, some embodiments relate to localization of a vehicle.

### DESCRIPTION OF RELATED ART

Localization is the task of estimating the location and/or trajectory (i.e. directional path) of an object with respect to a global reference frame (e.g. the center of the earth). For example, vehicles may use satellite or map based-localization techniques to estimate their location/trajectory with respect to a global reference frame. This location/trajectory may be used for navigation, advanced safety systems, and autonomous driving systems.

Radiolocation (also known as radio-triangulation or radio-positioning) is the process of estimating the relative location and/or velocity of an object through the use of radio waves. Many conventional vehicles are equipped with radio receivers (e.g. antennas), and are thus capable of estimating the relative location/velocity of other objects/vehicles which transmit radio waves.

### BRIEF SUMMARY OF THE DISCLOSURE

According to various embodiments of the disclosed technology, a vehicle is provided. The vehicle, in accordance with embodiments of the technology disclosed herein comprises an electronic control unit (ECU) including machine executable instructions in non-transitory memory to perform a method comprising: (a) receiving one or more localization packets, each localization comprising a location of an associated transmitter vehicle with respect to a global reference frame and a transmission timestamp; (b) estimating a relative location for the vehicle using radiolocation, the relative location comprising a location of the vehicle relative to the one or more transmitter vehicles; and (c) estimating a collaborative localization for the vehicle, the collaborative localization comprising a location of the vehicle with respect to the global reference frame. In some embodiments, estimating the relative location of the vehicle using radiolocation may comprise: (1) calculating a distance between the vehicle and each of the one or more transmitter vehicles using the one or more transmission timestamps; and (2) estimating a location of the vehicle relative to the one or more transmitter vehicles.

In various embodiments, a transmitter vehicle is provided. The transmitter vehicle, in accordance with embodiments of the technology disclosed herein comprises an ECU including machine executable instructions in non-transitory memory to perform a method comprising: (a) estimating a localization for the transmitter vehicle, the localization comprising a location of the transmitter vehicle relative to a global reference frame; and (b) transmitting a localization packet to one or more vehicle using wireless communication, the localization packet comprising the estimated localization of the transmitter vehicle and a transmission timestamp. In some embodiments, the transmitter vehicle may further comprise an imaging sensor and a proximity sensor. In these embodiments, estimating a localization for the transmitter vehicle may comprise: (1) detecting a landmark using the imaging sensor; (2) estimating a location of the transmitter vehicle relative to the landmark using the proximity sensor; (3) correlating the landmark to a map; and (4) estimating a location of the transmitter vehicle relative to the global reference frame.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture which can be used by a transmitter vehicle to transmit localization packets to other vehicles, in accordance with embodiments of the systems and methods described herein.

FIG. 3 illustrates an example architecture which can be used by a vehicle to receive localization packets and estimate its location with respect to a global reference frame using radiolocation, in accordance with embodiments of the systems and methods described herein.

FIG. 4 illustrates example operations that can be performed by a transmitter vehicle to estimate its localization and transmit localization packets to other vehicles, in accordance with embodiments of the systems and methods described herein.

FIG. 5 illustrates example operations that can be performed by a vehicle to estimate its localization using localization packets received from transmitter vehicles and radiolocation, in accordance with embodiments of the systems and methods described herein.

FIG. 6 is a diagram which illustrates how a vehicle may use radiolocation to estimate its location relative to one or more transmitter vehicles, in accordance with embodiments of the systems and methods described herein.

FIG. 7 is a diagram which illustrates how a vehicle may use radiolocation to estimate its velocity relative to one or more transmitter vehicles, in accordance with embodiments of the systems and methods described herein.

FIG. 8 is another diagram which illustrates how a vehicle may use radiolocation to estimate its velocity relative to one or more transmitter vehicles, in accordance with embodiments of the systems and methods described herein.

FIG. 9 is an example computing component that may be used to implement various features of embodiments described in the present disclosure.

The figures are not exhaustive and do not limit the present disclosure to the precise form disclosed.

### DETAILED DESCRIPTION

As alluded to above, a vehicle may use localization techniques to estimate its location and/or trajectory with respect to a global reference frame. Certain vehicles are able to localize themselves more accurately than others. In part, this is because certain vehicles have more precise/specialized sensors used for localization. For example, some vehicles are equipped with high sensitivity odometry equipment which can be used for high accuracy localization. Similarly, certain vehicles use on-board imaging and proximity sensors (e.g. cameras, radar, lidar, etc.) to correlate detected landmarks to map data in order to accurately localize themselves.

Other vehicles rely on more basic/rudimentary sensors for localization (e.g. basic odometry equipment and Global Navigation Satellite System (GNSS) sensors). These vehicles are unable to localize themselves with as much accuracy as vehicles equipped with more specialized localization sensors.

Accordingly, embodiments of the presently disclosed technology use a collaborative approach to share high-accuracy localization data with vehicles which may lack specialized localization sensors. In particular, one or more vehicles that are able to localize themselves with high accuracy (e.g. transmitter vehicles) may transmit timestamped localization information (e.g. localization packets) to nearby vehicles, which may lack high-accuracy localization sensors. Each localization packet may include the location of the associated transmitter vehicle with respect to a global reference frame. Upon receiving the localization packets, a vehicle may use radiolocation techniques to estimate its location relative to the transmitter vehicle(s). Based on this estimation and the information in the localization packets, the vehicle may then estimate its location with respect to the global reference frame. Additionally, the vehicle may estimate it's trajectory with respect to the global reference frame using radiolocation techniques such as doppler shift, or, by tracking successive localization estimates along a path. In these ways, the high-accuracy localization capability of a subset of vehicles may be extended to a larger vehicle population.

Accordingly, embodiments of the presently disclosed technology may be used by OEMs to improve the localization accuracy of their fleets by providing only a small subset of vehicles with specialized sensor suites. Similarly, the localization accuracy of a larger vehicle population may be improved by installing specialized localization sensors on a subset of high-mileage vehicles such as taxis, ride share vehicles, and patrol vehicles.

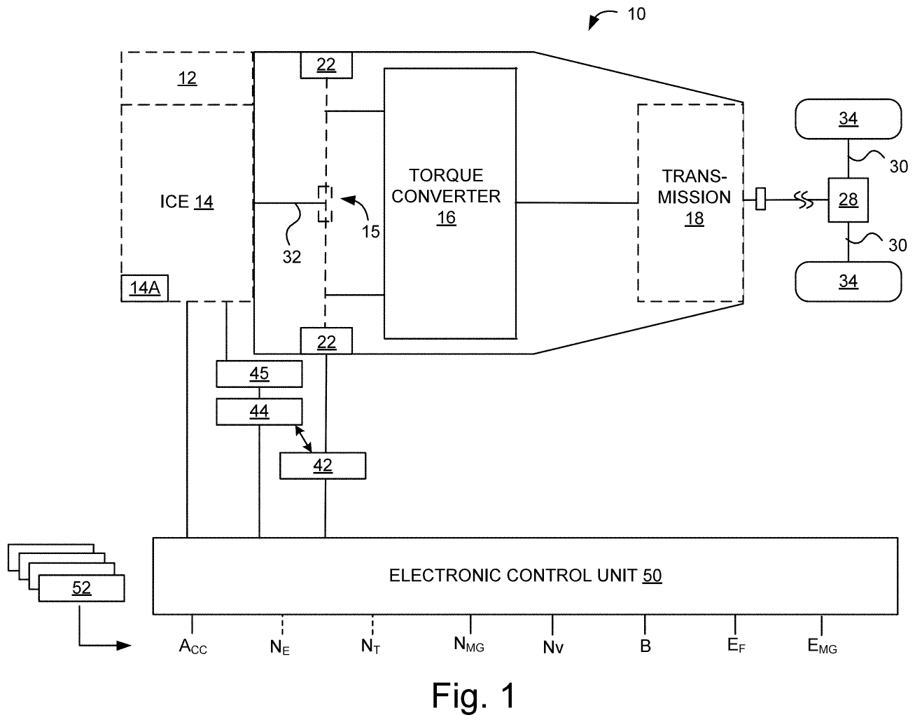

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for collaborative localization can be implemented in other types of vehicle including gasoline- or diesel-powered vehicles, fuel-cell vehicles, electric vehicles, or other vehicles. It should be understood that the example vehicle described in conjunction with FIG. 1 may be either a transmitter vehicle (i.e. a vehicle which transmits high accuracy localization information to other vehicles), or a non-transmitter vehicle. Areas in which these vehicles may differ will be highlighted in the description of FIG. 1.

FIG. 1 illustrates a drive system of a vehicle 10 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16 and/or clutch 15, a transmission 18, a differential gear device 28, and a pair of axles 30.

As an HEV, vehicle 10 may be driven/powered with either or both of internal combustion engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses internal combustion engine 14 and the motor(s) 22 as the sources of motive power. In the engine-only and HEV travel modes, vehicle 10 relies on the motive force generated at least by internal combustion engine 14, and a clutch 15 may be included to engage internal combustion engine 14. In the EV travel mode, vehicle 10 is powered by the motive force generated by motor 22 while internal combustion engine 14 may be stopped and clutch 15 disengaged.

Internal combustion engine 14 can be an internal combustion engine such as a gasoline, diesel or similarly powered engine in which fuel is injected into and combusted in a combustion chamber. A cooling system 12 can be provided to cool the internal combustion engine 14 such as, for example, by removing excess heat from internal combustion engine 14. For example, cooling system 12 can be implemented to include a radiator, a water pump and a series of cooling channels. In operation, the water pump circulates coolant through the internal combustion engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of internal combustion engine 14. In other applications, either or both the water pump and the fan may be operated by electric current such as from battery 44.

An output control circuit 14A may be provided to control drive (output torque) of internal combustion engine 14. Output control circuit 14A may include a throttle actuator to control an electronic throttle valve that controls fuel injection, an ignition device that controls ignition timing, and the like. Output control circuit 14A may execute output control of internal combustion engine 14 according to a command control signal(s) supplied from an electronic control unit 50, described below. Such output control can include, for example, throttle control, fuel injection control, and ignition timing control.

Motor 22 can also be used to provide motive power in vehicle 10 and may be powered electrically via a battery 44. More specifically, motor 22 can be powered by battery 44 to generate motive force to move the vehicle and adjust vehicle speed. Motor 22 can also function as a generator to generate electrical power such as, when coasting or braking. Motor 22 may be connected to battery 44 via an inverter 42. Battery 44 may also be used to power other electrical or electronic systems in the vehicle. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from internal combustion engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage internal combustion engine 14 from the drivetrain of the vehicle. In the illustrated example, a crankshaft 32, which is an output member of internal combustion engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from internal combustion engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 10 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, a collaborative localization module, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using one or more separate electronic control units, or using a single electronic control unit.

In the example illustrated in FIG. 1, electronic control unit 50 receives information from a plurality of sensors 52 included in vehicle 10. As alluded to above, depending on whether vehicle 10 is transmitter vehicle or a non-transmitter vehicle, sensors 52 may be different.

For example, if vehicle 10 is a transmitter vehicle, sensors 52 may include imaging sensors (such as cameras), and proximity sensors (such as radar, lidar, and sonar) which may be used to detect/identify landmarks (e.g. road signs, lane markings, traffic signals, infrastructure, etc.). As will be described below, electronic control unit 50 may correlate these detected landmarks to pre-constructed maps in order to localize vehicle 10 with a high degree of accuracy. In some embodiments, sensors 52 may also include high sensitivity odometry equipment which may be similarly used to localize vehicle 10 with a high degree of accuracy.

If vehicle 10 is a non-transmitter vehicle, sensors 52 may include more basic/rudimentary sensors used for localization. For example, sensors 52 may include standard odometry equipment and GNSS sensors which are capable of localizing vehicle 10 with a lesser degree of accuracy than would imaging/proximity sensors or high sensitivity odometry equipment.

Whether vehicle 10 is a transmitter vehicle or a non-transmitter vehicle, sensors 52 may include sensors which detect the operating conditions and/or characteristics of vehicle 10. These may include, but are not limited to sensors which detect accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 10 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

As alluded to above, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

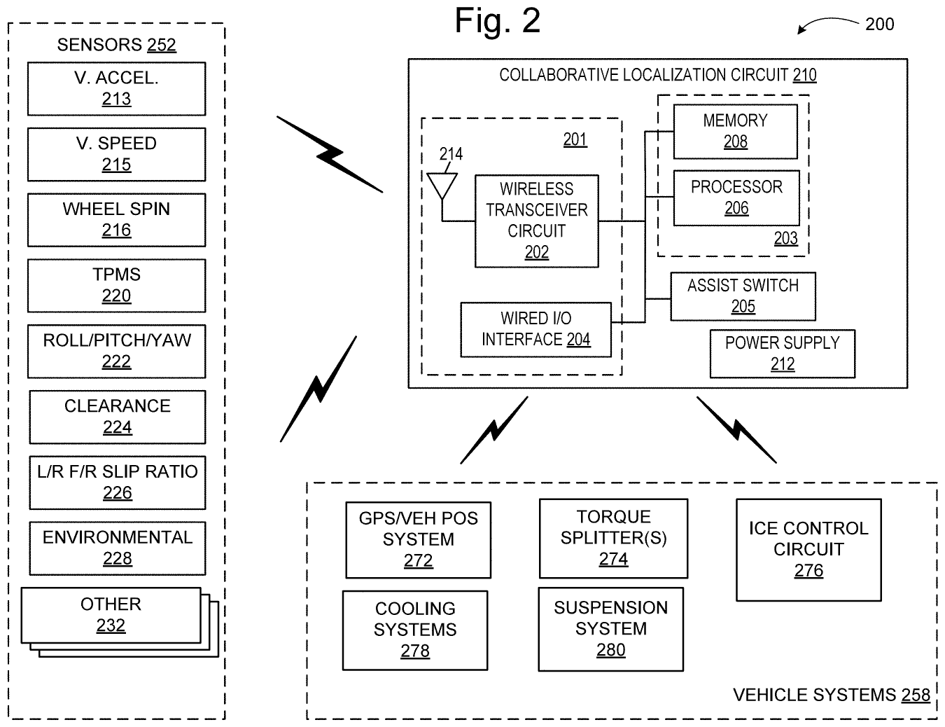

FIG. 2 illustrates an example architecture which can be used by a transmitter vehicle to estimate a localization for the transmitter vehicle and transmit localization packets to other vehicles, in accordance with one embodiment of the systems and methods described herein. Referring now to FIG. 2, in this example, collaborative localization system 200 includes a collaborative localization circuit 210, a plurality of sensors 252, and a plurality of vehicle systems 258. Sensors 252 and vehicle systems 258 can communicate with collaborative localization circuit 210 via a wired or wireless communication interface. Although sensors 252 and vehicle systems 258 are depicted as communicating with collaborative localization circuit 210, they can also communicate with each other as well as with other vehicle systems. Collaborative localization circuit 210 can be implemented as an ECU or as part of an ECU such as, for example electronic control unit 50. In other embodiments, collaborative localization circuit 210 can be implemented independently of an ECU.

Collaborative localization circuit 210 in this example includes a communication circuit 201, a decision circuit (including a processor 206 and memory 208 in this example) and a power supply 212. Components of collaborative localization circuit 210 are illustrated as communicating with each other via a data bus, although other communication in interfaces can be included. Collaborative localization circuit 210 in this example also includes a manual assist switch 205 that can be operated by the user to manually select the collaborative localization mode.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a collaborative localization circuit 210.

Communication circuit 201 may include either or both of a wireless transceiver circuit 202 with an associated antenna 214 and a wired I/O interface 204 with an associated hardwired data port (not illustrated). As this example illustrates, communications with collaborative localization circuit 210 can include either or both wired and wireless communications. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. For example, wireless transceiver circuit 202 may transmit localization packets to other vehicles via antenna 214. These localization packets can include information of almost any sort that is sent or received by collaborative localization circuit 210 to/from other entities such as sensors 252 and vehicle systems 258. For example, these localization packets may include detected/estimated locations and velocities for vehicle 10 received from sensors 252. These localization packets may also include a timestamp of when the localization packet was transmitted from antenna 214. In some embodiments, antenna 214 may comprise multiple antennas coupled to wireless transceiver circuit 202. Accordingly, localization packets may be transmitted from any of these antennas.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 52 such as those described above with reference to the example of FIG. 1. Sensors 252 can also include additional sensors that may or not otherwise be included on a standard vehicle 10 with which collaborative localization system 200 is implemented. In the illustrated example, sensors 252 include vehicle acceleration sensors 213, vehicle speed sensors 215, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions).

Additional sensors 232 can also be included as may be appropriate for a given implementation of collaborative localization system 200. For example, as alluded to above, additional sensors 232 may include imaging sensors (such as cameras) and proximity sensors (such as radar, lidar, and sonar) which may be used to detect/identify landmarks (e.g. road signs, lane markings, traffic signals, infrastructure, etc.). Sensors 252 may also include high sensitivity odometry equipment which may be similarly used to localize vehicle 10 with a high degree of accuracy. In some embodiments, these sensors may be a part of GPS or other vehicle positioning system 272.

Vehicle systems 258 can include any of a number of different vehicle components or subsystems used to control or monitor various aspects of the vehicle and its performance. In this example, the vehicle systems 258 include a GPS or other vehicle positioning system 272; torque splitters 274 which can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; and suspension system 280 such as, for example, an adjustable-height air suspension system.

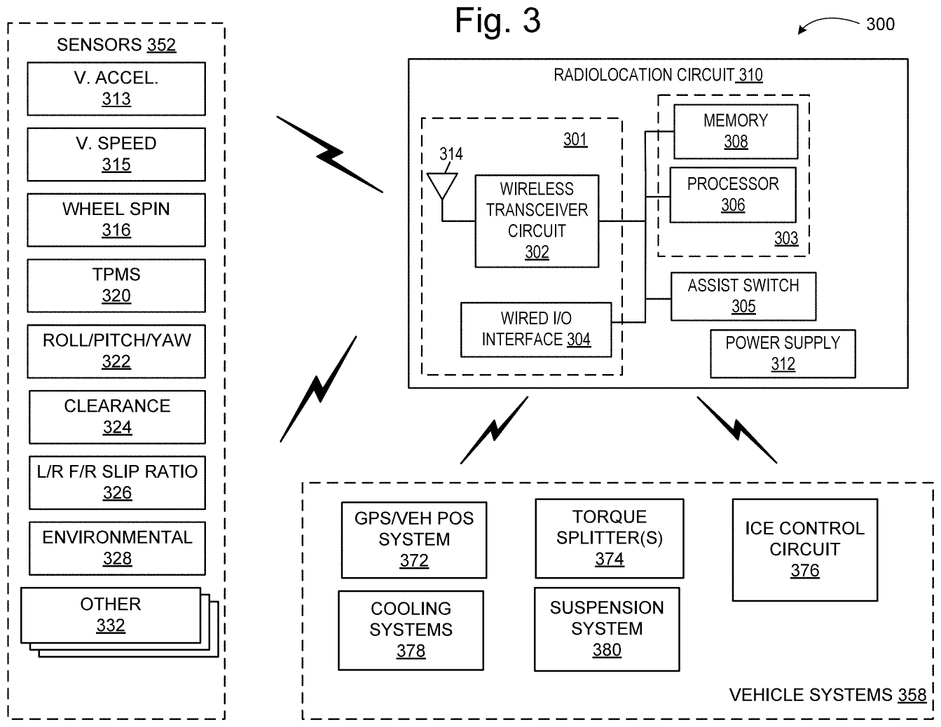

FIG. 3 illustrates an example architecture which can be used by a vehicle to receive localization packets and estimate its location and trajectory with respect to a global reference frame using radiolocation. Referring now to FIG. 3, in this example, radiolocation system 300 includes a radiolocation circuit 310, a plurality of sensors 352, and a plurality of vehicle systems 358. Sensors 352 and vehicle systems 358 can communicate with radiolocation circuit 310 via a wired or wireless communication interface. Although sensors 352 and vehicle systems 358 are depicted as communicating with radiolocation circuit 310, they can also communicate with each other as well as with other vehicle systems. Radiolocation circuit 310 can be implemented as an ECU or as part of an ECU such as, for example electronic control unit 50. In other embodiments, radiolocation circuit 310 can be implemented independently of an ECU.

Radiolocation circuit 310 in this example includes a communication circuit 301, a decision circuit (including a processor 306 and memory 308 in this example) and a power supply 312. Components of radiolocation circuit 310 are illustrated as communicating with each other via a data bus, although other communication in interfaces can be included. Radiolocation circuit 310 in this example also includes a manual assist switch 305 that can be operated by the user to manually select the radiolocation mode.

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308, can be made up of one or more modules of one or more different types of memory, and may be configured to store data and other information as well as operational instructions that may be used by the processor 306.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a radiolocation circuit 310.

Communication circuit 301 may include either or both of a wireless transceiver circuit 302 with an associated antenna 314 and a wired I/O interface 304 with an associated hardwired data port (not illustrated). As this example illustrates, communications with radiolocation circuit 310 can include either or both wired and wireless communications. Wireless transceiver circuit 302 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and may be used to receive localization packets transmitted by transmitter vehicles. In some embodiments, antenna 314 may comprise multiple antennas coupled to wireless transceiver circuit 302. Accordingly, localization packets may be received at any of these antennas.

Wired I/O interface 304 can include a transmitter and a receiver (not shown) for hardwired communications with other devices. For example, wired I/O interface 304 can provide a hardwired interface to other components, including sensors 352 and vehicle systems 358. Wired I/O interface 304 can communicate with other devices using Ethernet or any of a number of other wired communication protocols whether standardized, proprietary, open, point-to-point, networked or otherwise.

Power supply 312 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 352 can include, for example, sensors 52 such as those described above with reference to the example of FIG. 1. Sensors 352 can also include additional sensors that may or not otherwise be included on a standard vehicle 10 with which radiolocation system 300 is implemented. In the illustrated example, sensors 352 include vehicle acceleration sensors 313, vehicle speed sensors 315, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, and environmental sensors 328 (e.g., to detect salinity or other environmental conditions).

Additional sensors 332 can also be included as may be appropriate for a given implementation of radiolocation system 300. For example, as alluded to above, additional sensors 232 may include basic/rudimentary sensors for localization (e.g. basic odometry equipment and Global Navigation Satellite System (GNSS) sensors). In some embodiments, these sensors may be a part of GPS or other vehicle positioning system 372.

Vehicle systems 358 can include any of a number of different vehicle components or subsystems used to control or monitor various aspects of the vehicle and its performance. In this example, the vehicle systems 358 include a GPS or other vehicle positioning system 372; torque splitters 374 which can control distribution of power among the vehicle wheels such as, for example, by controlling front/rear and left/right torque split; engine control circuits 376 to control the operation of engine (e.g. Internal combustion engine 14); cooling systems 378 to provide cooling for the motors, power electronics, the engine, or other vehicle systems; and suspension system 380 such as, for example, an adjustable-height air suspension system.

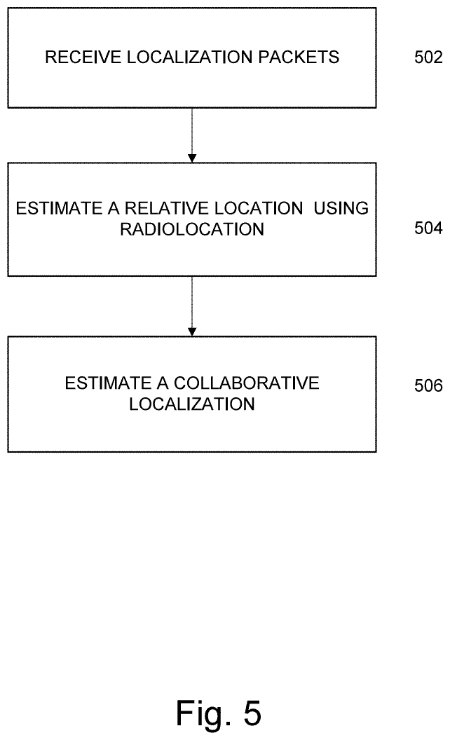

During operation, radiolocation circuit 310 can receive information from wireless transceiver circuit 302 and various sensors 352 in order to estimate a location and trajectory for the vehicle with respect to a global reference frame using radiolocation. This process will be described in greater detail in conjunction with FIGS. 5-8.

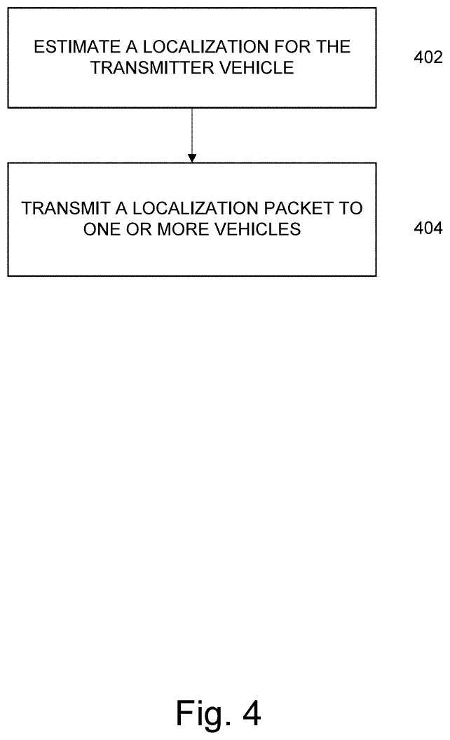

FIG. 4 illustrates example operations that can be performed by a transmitter vehicle to transmit a localization packet to other vehicles. In certain embodiments, these operations may be performed by collaborative localization circuit 210.

At operation 400 the transmitter vehicle estimates a localization for the transmitter vehicle. The localization may comprise a location of the transmitter vehicle with respect to a global reference frame (such as the center of the earth). In some embodiments, the localization may further comprise a velocity of the transmitter vehicle with respect to the global reference frame.

A transmitter vehicle may be a vehicle capable of localizing itself with a high degree of accuracy. In some embodiments, this high degree of accuracy may be defined as accuracy sufficient to identify which lane of a road the transmitter vehicle is traveling in.

In some embodiments, a transmitter vehicle may be equipped with high sensitivity odometry equipment that can be used to make high accuracy localization estimates. In certain embodiments, a transmitter vehicle may be equipped with on-board imaging and proximity sensors (e.g. radar, lidar, cameras, etc.) which may be used to correlate observed landmarks (e.g. road signs, lane markings, traffic signals, infrastructure, etc.) to pre-constructed maps of an area in order to localize the transmitter vehicle with a high degree of accuracy.

Accordingly, a transmitter vehicle may estimate its localization by various methods. For example, a transmitter vehicle may detect a landmark using its imaging sensors and estimate a its location relative to the landmark based on its proximity sensors. The transmitter vehicle may also correlate the landmark to a pre-constructed map. In this way, the transmitter vehicle may estimate its location with respect to the global reference frame based on the correlation and its estimated location relative to the landmark.

The transmitter vehicle may estimate its localization using any of the sensors/techniques described above. However, it should be understood that the transmitter vehicle may estimate its localization using various other known sensors/techniques capable of localizing a vehicle with a high degree of accuracy.

At operation 402 the transmitter vehicle transmits a localization packet to one or more other vehicles. In some embodiments, the localization packet may be transmitted by wireless transceiver circuit 202 via antenna 214 (which may comprise multiple antennas).

The localization packet may be an electromagnetic wave (e.g. a radio wave) comprising an estimated localization of the transmitter vehicle and a timestamp of when the localization packet was transmitted (embodiments assume that the clocks of the transmitter vehicle and other vehicles have been synchronized using established techniques). In certain embodiments, the localization packet may also comprise uncertainty information related to the localization estimate.

Accordingly, the localization packet may be received by one or more other vehicles, such as the vehicle described in conjunction with FIG. 5.

FIG. 5 illustrates example operations that can be performed by a vehicle to estimate its localization using received localization packets and radiolocation. In certain embodiments, these operations may be performed by radiolocation circuit 310.

At operation 500 the vehicle receives one or more localization packets, each localization packet having been transmitted by a transmitter vehicle. In some embodiments the localization packets may be received by antenna 314 (which may comprise multiple antennas) and wireless transceiver circuit 302.

As alluded to above, each localization packet may be an electromagnetic wave comprising a location of the transmitter vehicle with respect to a global reference frame, and a transmission timestamp. In some embodiments, the localization packet may further comprise a velocity of the transmitter vehicle with respect to a global reference frame. In certain embodiments, the localization packet may also comprise uncertainty information.

At operation 504, the vehicle estimates its location relative to the one or more transmitter vehicles (i.e. its relative location).

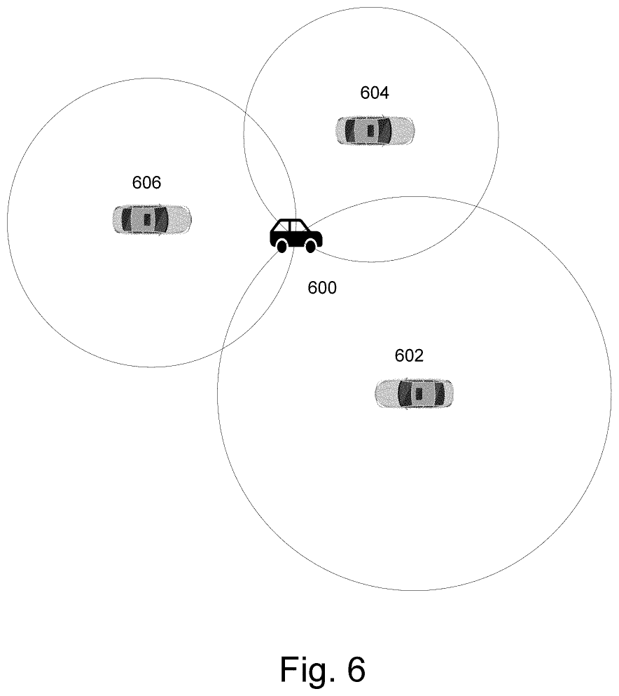

As will be described in greater detail in conjunction with FIG. 6, the vehicle may estimate its relative location by calculating a distance between itself and each transmitter vehicle based on the timestamps contained in the localization packets. Accordingly, the vehicle may use these distances to estimate its location relative to the transmitter vehicles.

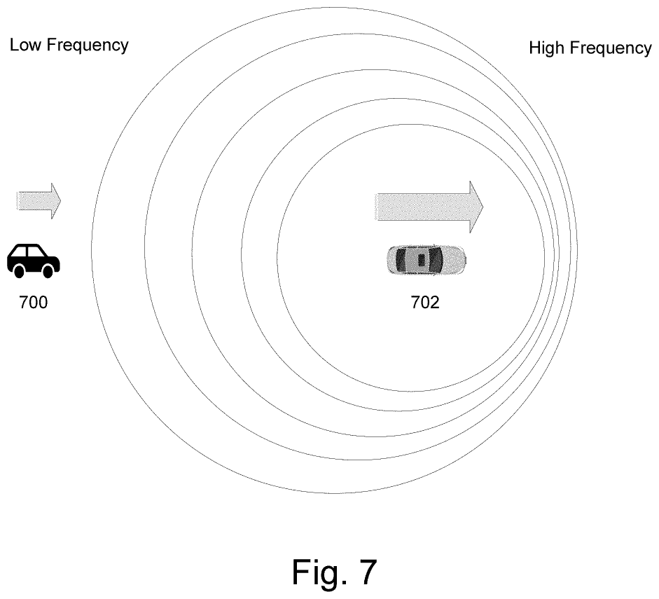

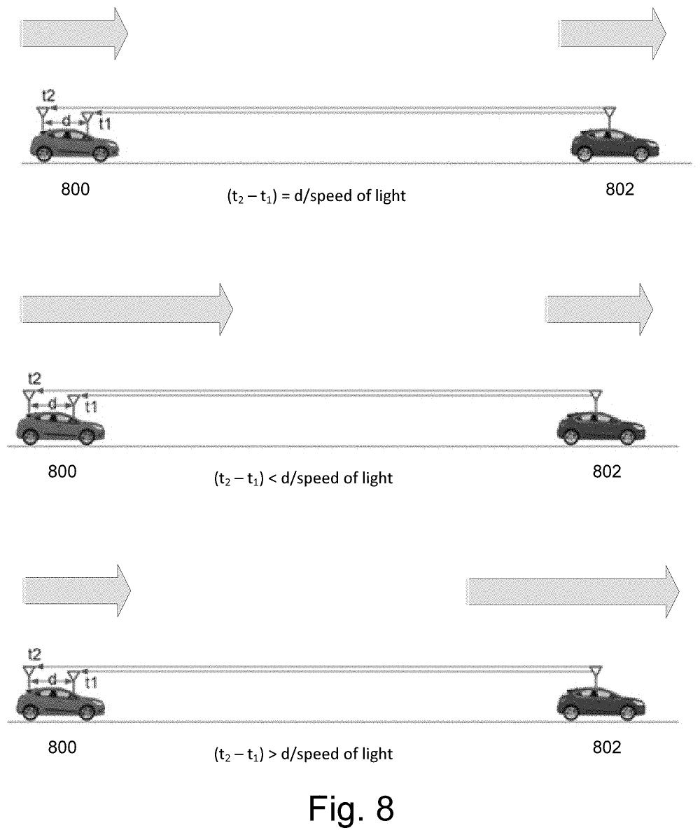

As will be described in greater detail in conjunction with FIGS. 7 and 8, the vehicle may also use various radiolocation techniques to calculate its velocity relative to one or more of the transmitter vehicles. For example, the vehicle may utilize the doppler effect/doppler shift, or receive the same localization a packet at multiple antennas.

Based on the information contained in one or more of the received localization packets and the relative location estimate made at operation 502, at operation 504, the vehicle estimates a collaborative localization. The collaborative localization may be a location of the vehicle with respect to the global reference frame. For example, the vehicle may compare one localization estimate for a transmitter vehicle (e.g. 40° 44′ 24.0504″ N, 74° 15′ 35.4096″ W) to the location estimate the vehicle made for itself relative to the transmitter vehicle (e.g. 1.0″ south, 1.0″ west of the transmitter vehicle). In this way, the vehicle may estimate its own location with respect to the global reference frame (e.g. 40° 44′ 23.0504″ N, 74° 15′ 36.4096″ W). In certain embodiments, the vehicle may use the localization estimates of multiple transmitter vehicles in order to estimate its own location with respect to the global reference frame. In these embodiments, the vehicle may calculate an average location for itself with respect to the global reference frame based on the localization estimates of the transmitter vehicles and its estimated location relative to the transmitter vehicles.

In various embodiments, the vehicle may filter collaborative localization estimates based on accuracy. For example, in certain situations a radio wave carrying a localization packet may reflect off of infrastructure such as a building. The reflected radio wave may then be received by a vehicle. Due to the reflected path of the radio wave, the vehicle may not be able to calculate a correct/accurate distance between the transmitter vehicle and the vehicle. Accordingly, the collaborative localization estimate based on this reflected localization packet may be inaccurate. However, the vehicle may use its own sensors (e.g. equipped GNSS sensors) to determine that a particular collaborative localization estimate is inaccurate. For example, a vehicle may use its own sensors (which may be part of an on-board GPS system) to generate a first localization estimate. Accordingly, the vehicle may compare this first localization estimate to a collaborative localization estimate. If the deviation between the first localization estimate and the collaborative localization estimate exceeds a threshold value, the vehicle may ignore/exclude the localization packets which formed a basis for the collaborative localization estimate. In this way, a vehicle may filter collaborative localization estimates based on accuracy.

Finally, as alluded to above, the vehicle may also estimate its own trajectory with respect to the global reference frame based on information contained in the received localization packets and the relative velocity estimates made at operation 402. For example, the vehicle may compare the velocity of a transmitter vehicle with respect to a global reference frame (contained in the localization packet transmitted by that vehicle) to a determined relative velocity between the vehicle and the transmitter vehicle. Based on this comparison, the vehicle may estimate its own velocity with respect to the global reference frame, and by extension, determine its trajectory with respect to the global reference frame.

In other embodiments, the vehicle may estimate its trajectory with respect to a global reference frame by tracking successive localization estimates along a path. In this way, a trajectory with respect to a global reference frame may be discerned.

FIG. 6 illustrates how a vehicle may use radiolocation to estimate its location relative to one or more transmitter vehicles, in accordance with various embodiments of the technology described herein. In the figure, transmitter vehicles 602, 604, and 606 are each transmitting localization packets, which vehicle 600 is receiving. In certain embodiments, the localization packets may be transmitted by one or more antennas equipped on the transmitter vehicles, and received by one or more antennas equipped on vehicle 600.

As alluded to above, each localization packet contains a transmission timestamp. Based on this time-stamp, vehicle 600 may calculate transmission times (i.e. the time between transmission of each localization packet, and receipt by vehicle 600). Based on these transmission times and the speed of light, vehicle 600 may calculate how far the localization packet has traveled. Assuming neither vehicle is approaching the speed of light (unlikely), this distance will be the approximate distance between the transmitter vehicle and vehicle 600 (or more precisely, this distance will be the distance between the transmitting antenna of the transmitter vehicle and the receiving antenna of vehicle 600). These distances are represented by the three circles in the figure centered around transmitter vehicles 602, 604, and 606 respectively.

It should be understood that the accuracy with which vehicle 600 is able to estimate its relative location may depend on the number of transmitter vehicles it receives localization packets from. For example, if vehicle 600 only receives a localization packet from transmitter vehicle 602, vehicle 600 may estimate its relative location to be somewhere along the circumference of the circle centered around transmitter 602. This is because vehicle 600 may calculate the distance between transmitter vehicle 602 and vehicle 600 (represented by the circle centered around transmitter vehicle 602) based on the aforementioned radiolocation techniques. However, if vehicle 600 receives localization packets from transmitter vehicles 602 and 604, it may estimate its relative location more accurately. In particular, vehicle 600 may estimate its relative location to be at either intersection point of the circles centered around transmitter vehicles 602 and 604. This is because vehicle 600 can calculate the distance (represented by the circles) between it and transmitter vehicles 602 and 604 respectively. Accordingly, there are only two locations in the two-dimensional space where the two circles having dissimilar centers intersect. By the same token, if vehicle 600 receives localization packets from all three transmitter vehicles, it can estimate its relative location even more accurately. In particular, vehicle 600 may estimate its relative location to be at the single point in the two-dimensional space where all three circles intersect. Finally while FIG. 6 is a two-dimensional representation of radiolocation, the same process may be performed in three dimensions. Here, the circles centered around the transmitter vehicles may be replaced by spheres (which represent the distances, in three dimensions, between vehicle 600 and each transmitter vehicle). Similarly, vehicle 600 may estimate its relative location more accurately if it were to receive a localization packet from a fourth transmitter vehicle.

FIG. 7 illustrates how a vehicle may estimate its velocity relative to a transmitter vehicle using doppler shift. In the figure, transmitter vehicle 702 is traveling faster than vehicle 700. Thus there is a relative velocity between the two vehicles. Similar to FIG. 6, transmitter vehicle 702 has transmitted a localization packet, which vehicle 700 is set to receive.

Doppler shift is the change in frequency of a wave in relation to an observer who is moving relative to the wave source. Using doppler shift, vehicle 700 may estimate its radial velocity relative to transmitter vehicle 702 (i.e. the rate of change of the distance between vehicle 700 and transmitter vehicle 702) by comparing the shifted frequency of the localization packet it receives to a known unshifted frequency. In some embodiments, the unshifted frequency of the localization packet may be a known standard, e.g. 101.9 MHz, or in some embodiments the unshifted frequency may be part of the information contained in the localization packet.

Here, because vehicle 700 and transmitter vehicle 702 are moving away from each other, the frequency of the localization packet which vehicle 700 receives/observes is lower than the unshifted frequency of the localization packet. Assuming that vehicle 700 knows the unshifted frequency of the localization packet, vehicle 700 may estimate a relative radial velocity by calculating the difference between the frequency of the localization packets it receives, and the known unshifted frequency. As alluded above, the accuracy with which vehicle 700 may estimate its relative velocity may depend on the number of transmitter vehicles it receives localization packets from. In particular, if vehicle 700 were to only receive a localization packet from a single transmitter vehicle, it may only estimate its radial velocity (in any direction) relative to the transmitter vehicle. However, if vehicle 700 were to receive localization packets from additional transmitter vehicles, it may estimate its velocity relative to the transmitter vehicles with greater accuracy.

FIG. 8 illustrates how a vehicle may estimate its relative velocity by receiving the same localization packets at multiple antennas. Similar to FIG. 7, transmitter vehicle 802 is transmitting localization packets, which vehicle 800 is receiving.

As depicted, vehicle 800 has two antennas, one at the front of vehicle 800, and one at the back. The two antennas are separated by a known distance, d. Accordingly, vehicle 800 may receive the same localization packet at a first time, t₁, at the front antenna, and a later time, t₂, at the back antenna.

When there is no relative velocity between vehicles 800 and 802 (e.g. neither vehicle is moving, or both vehicles are moving at the same speed in the same direction), (t₂−t₁)=d/(speed of light).

However, when vehicles 800 and 802 are moving relative to each other, this equality may not hold. For example, if vehicle 800 and transmitter vehicle 802 are moving closer to each other, (t₂−t₁)<d/(speed of light). By contrast, if vehicle 800 and transmitter vehicle 802 are moving farther apart, (t₂−t₁)>d/(speed of light). Accordingly, based on the relationship between “(t₂−t₁)”, “d”, and the speed of light, vehicle 800 may calculate its radial velocity relative to transmitter vehicle 802. As alluded to above, vehicle 800 may estimate its relative velocity with more accuracy if it receives localization packets from multiple transmitter vehicles.

Once it has estimated its velocity relative to one or more transmitter vehicles, a vehicle (such as vehicle 700 or 800) may use the information contained in localization packets to estimate its velocity relative to a global reference frame. In particular, when a localization packet contains the velocity of a transmitter vehicle with respect to a global reference frame, the vehicle may use this information to estimate its own velocity with respect to the global reference frame. In turn, this estimation may be used to estimate the trajectory of the vehicle (as the velocity of the vehicle with respect to the global reference frame includes the direction the vehicle is traveling with respect to the global reference frame).

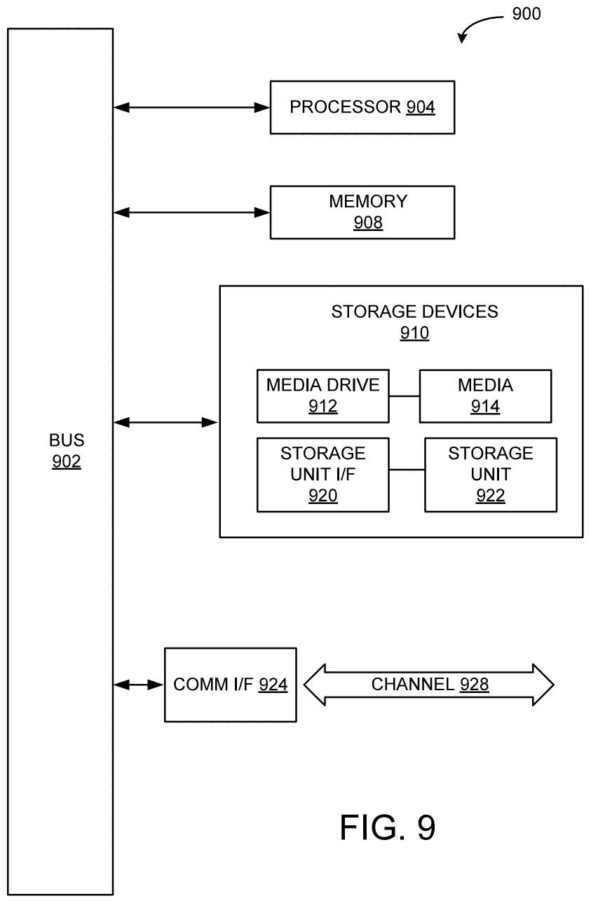

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle comprising:
an electronic control unit (ECU) including machine executable instructions in non-transitory memory to perform a method comprising:
receiving one or more localization packets, each localization comprising a location of an associated transmitter vehicle with respect to a global reference frame and a transmission timestamp;
estimating a relative location for the vehicle using radiolocation, the relative location comprising a location of the vehicle relative to the one or more transmitter vehicles; and
estimating a collaborative localization for the vehicle, the collaborative localization comprising a location of the vehicle with respect to the global reference frame.

2. The vehicle of claim 1, wherein estimating the relative location of the vehicle using radiolocation comprises:
calculating a distance between the vehicle and each of the one or more transmitter vehicles using the one or more transmission timestamps; and
estimating a location of the vehicle relative to the one or more transmitter vehicles.

3. The vehicle of claim 1, wherein the method further comprises filtering the collaborative localization of the vehicle based on accuracy.

4. The vehicle of claim 3, wherein filtering the collaborative localization of the vehicle comprises:
comparing the collaborative localization to a first localization estimated by a Global Positioning System (GPS) in the vehicle; and
excluding the collaborative localization when it exceeds a threshold deviation from the first localization estimate.

5. The vehicle of claim 1, wherein the collaborative localization further comprises a trajectory of the vehicle with respect to the global reference frame.

6. The vehicle of claim 5, wherein:
each localization packet further comprises a velocity of its associated transmitter vehicle with respect to the global reference frame; and
the method further comprises:
estimating one or more relative velocities, each relative velocity comprising a velocity of the vehicle relative to a transmitter vehicle; and
estimating a trajectory of the vehicle with respect to the global reference frame.

7. The vehicle of claim 6, wherein estimating each of the one or more relative velocities comprises using doppler shift.

8. The vehicle of claim 6, wherein:
the vehicle further comprises at least a first and a second antenna separated by a known distance, each antenna configured to receive the one or more localization packets; and
estimating each of the one or more relative velocities comprises:
receiving a localization packet at the first antenna at a first time, and at the second antenna at second time;
comparing the difference between the first and second time to a known distance; and
determining a relative radial velocity between the vehicle and the transmitter vehicle associated with the localization packet.

9. A transmitter vehicle comprising:
an ECU including machine executable instructions in non-transitory memory to perform a method comprising:
estimating a localization for the transmitter vehicle, the localization comprising a location of the transmitter vehicle relative to a global reference frame; and
transmitting a localization packet to one or more vehicle using wireless communication, the localization packet comprising the estimated localization of the transmitter vehicle and a transmission timestamp.

10. The transmitter vehicle of claim 9 further comprising an imaging sensor and a proximity sensor.

11. The transmitter vehicle of claim 10, wherein estimating a localization for the transmitter vehicle comprises:
detecting a landmark using the imaging sensor;
estimating a location of the transmitter vehicle relative to the landmark using the proximity sensor;
correlating the landmark to a map; and
estimating a location of the transmitter vehicle relative to the global reference frame.

12. A computer-implemented method comprising:
generating, by an ECU in a vehicle, a first localization estimate, the first localization estimate comprising a first location of the vehicle with respect to a global reference frame;
receiving, by the ECU, one or more localization packets, each localization packet comprising a location of an associated transmitter vehicle with respect to the global reference frame and a transmission timestamp;
determining, by the ECU, a relative location for the vehicle using radiolocation, the relative location comprising a location of the vehicle relative to the one or more transmitter vehicles; and
refining, by the ECU, the first localization estimate, the refined localization estimate comprising a location of the vehicle with respect to the global reference frame.

13. The computer-implemented method of claim 12, wherein generating the first localization estimate comprises using a GPS in the vehicle.

14. The computer-implemented method of claim 12, wherein determining the relative location comprises:
calculating a distance between the vehicle and each of the one or more transmitter vehicles using the transmission timestamps; and
determining a location of the vehicle relative to the one or more transmitter vehicles.

15. The computer-implemented method of claim 12, wherein refining the first localization estimate comprises:
comparing the first localization estimate to a second localization estimate, wherein the second localization estimate is based on the one or more localization packets and the relative location of the vehicle, and comprises a second location of the vehicle with respect to the global reference frame; and
refining the first localization estimate based on the comparison.

16. The computer-implemented method of claim 15, wherein the first localization estimate is only refined when the deviation between the first and second localization estimate is within a threshold interval.

17. The computer-implemented method of claim 12, wherein the refined localization estimate further comprises a trajectory of the vehicle with respect to the global reference frame.

18. The computer-implemented method of claim 17, wherein:
each localization packet further comprises a velocity of its associated transmitter vehicle with respect to the global reference frame; and
the computer-implemented method further comprises:
determining one or more relative velocities, each relative velocity comprising a velocity of the vehicle relative to a transmitter vehicle; and
estimating a trajectory of the vehicle with respect to the global reference frame.

19. The computer-implemented method of claim 18, wherein determining each of the one or more relative velocities comprises using doppler shift.

20. The computer-implemented method of claim 18, wherein determining each of the one or more relative velocities comprises:
receiving a localization packet at a first antenna at a first time, and at a second antenna at second time;
comparing the difference between the first and second time to a known distance; and
determining a relative radial velocity between the vehicle and the transmitter vehicle associated with the localization packet.
